(19) United States
(12) Patent Application Publication
(10) Pub. No.: US 2026/0218636 A1
(43) Pub. Date: Jul. 30, 2026

(54) System and Method for Monitoring and Treating Wind Turbine Gear Oil

(71) Applicants: CHINA DATANG CORPORATION SCIENCE AND TECHNOLOGY GENERAL RESEARCH INSTITUTE CO.LTD, Hefei (CN); DATANG BOILER PRESSURE VESSEL INSPECTION CENTER CO., LTD., Hefei (CN); SHENHUA ENGINEERING TECHNOLOGY CO., LTD., Beijing (CN)

(72) Inventors: Huihui Han, Hefei (CN); Xing ZHANG, Hefei (CN); Muxin CHEN, Hefei (CN); Ye ZHAO, Hefei (CN); Xin WANG, Hefei (CN); Wei WU, Hefei (CN); Juan GU, Hefei (CN)

(21) Appl. No.: 19/402,990

(22) Filed: Nov. 27, 2025

Related U.S. Application Data
(63) Continuation of application No. PCT/CN2025/115792, filed on Aug. 20, 2025.

(30) Foreign Application Priority Data
Jan. 24, 2025 (CN) 202510116680.1

(51) Int. Cl. F01M 11/03; F01M 11/10; F03D 17/00

(52) U.S. Cl. CPC F01M 11/03; F01M 11/10; F03D 17/009; F01M 2250/60

(57) ABSTRACT

The present application discloses a system for monitoring and treating wind turbine gear oil, comprising an oil pump; the outlet end of the oil pump is connected to a viscosity detection module, a particle contamination detection module, a quality detection module, and a filtration module arranged in parallel; the outlet ends of the viscosity detection module, the particle contamination detection module, the quality detection module, and the filtration module are connected to an oil return port; the viscosity detection module comprises a constant temperature device therein; the filtration module comprises a filter tower, wherein magnetic rods, a mechanical filter, and a fine filter are sequentially arranged within the filter tower along the gear oil flow direction.

### TECHNICAL FIELD

The present application relates to a wind turbine generator unit, and more particularly to a system and method for monitoring and treating wind turbine gear oil.

### BACKGROUND

As one of the core components of a wind turbine, the gearbox operating condition directly determines the wind turbine service life. Gearbox failures in domestic wind turbine generator units occur frequently. According to statistics, gearbox failures are closely correlated with the quality of gearbox oil. Gear oil is the lifeblood of a wind turbine gearbox. During long-term operation under complex working conditions, the gearbox experiences pitting, fatigue spalling, wear and other phenomena on gear tooth surfaces, bearings and other components, generating metallic microparticles that become integrated into the gearbox oil. Therefore, oil monitoring constitutes an effective means for diagnosing wind turbine gearbox wear and operating conditions, thereby enhancing the operational safety and reliability of offshore wind power.

Wind turbine generator units impose extremely high requirements for stable equipment operation and safety assurance, particularly as offshore platforms constitute production facilities in relatively isolated environments where offshore operation and maintenance activities are significantly influenced by environmental factors. The traditional offline detection method involving gearbox oil sampling, laboratory testing, and data compilation and analysis is unsuitable for wind turbine gearbox oil detection due to inconvenient sampling, extended testing cycles, and susceptibility to influences from the operational procedures of sampling and testing personnel. Online monitoring of oil quality serves as a primary defense line for early warning in equipment maintenance and can effectively resolve the challenges that render wind turbines unsuitable for traditional sampling and detection methods. If research into an online monitoring system for quality of wind turbine gearbox oil can be undertaken, achieving online monitoring of key indicators, abnormal conditions in wind turbine gear oil may be detected in a timely manner.

Wind turbine gear oil filtration constitutes an effective means of improving the quality of gearbox oil, particularly with respect to wear conditions. Undertaking research into online filtration technology for wind turbine gearbox oil, and promptly treating abnormal gearbox oil, serves to prevent lubrication failure and subsequent wear of gear and bearing working surfaces, thereby avoiding the formation of a deleterious cycle between the oil and components, and consequently extending gear service life.

In the prior art, purification methods for gear oil exist, such as CN118775733A Wind Turbine Gear Oil Online Purification and Regeneration Method. However, no process for online monitoring of the gear oil is provided, and purification can only be performed manually at scheduled intervals, making timely purification unattainable. Since gear wear and gear oil degradation are non-linear processes, it is necessary to monitor the viscosity of the gear oil and particles content in real-time, followed by timely purification.

Therefore, conducting research on wind turbine gearbox oil online monitoring and filtration technology, developing online monitoring and filtration treatment apparatus, timely detecting abnormal conditions of wind turbine gearbox oil, providing early warnings and implementing appropriate remedial measures, and reducing unit wear-related failures, not only enhances equipment reliability and safety, but also reduces operation and maintenance costs throughout the equipment's entire service life, extends gear oil service life, ensures optimal lubrication conditions for the gearbox, and holds significant importance for achieving full-life high-performance healthy operation of wind turbine gearboxes.

The information disclosed in this Background is only intended to enhance understanding of the general background of the present application, and should not be taken as an acknowledgment or any form of suggestion that this information constitutes prior art already known to a person of ordinary skill in the art.

### SUMMARY

The technical problem to be solved by the present application is how to address the current situation in which wind turbine gear oil is sampled for offline detection, sampling is inconvenient, detection cycles are long, and the gear oil cannot be treated in a timely manner, thereby shortening the service life of gears.

The present application achieves resolution of the above technical problem through the following technical means:

A system for monitoring and treating wind turbine gear oil, comprising an oil pump; an outlet end of the oil pump is connected to a viscosity detection module, a particle contamination detection module, a quality detection module, and a filtration module arranged in parallel; outlet ends of the viscosity detection module, the particle contamination detection module, the quality detection module, and the filtration module are connected to an oil return port; the viscosity detection module comprises a constant temperature device therein; the filtration module comprises a filter tower, magnetic rods, a mechanical filter, and a fine filter are sequentially arranged in the filter tower along the gear oil flow direction.

The present application performs real-time detection of the viscosity, particle contamination level, and quality of wind turbine gear oil respectively through a viscosity detection module, a particle contamination detection module, and a quality detection module arranged in parallel. The gear oil after detection then returns to the wind turbine gear oil tank. When one or more indicators detected by the viscosity detection module, the particle contamination detection module, or the quality detection module fail to meet operational requirements, the filtration module is activated to perform filtration treatment on the gear oil to meet operational requirements. In the present application, the viscosity detection module comprises a constant temperature device to improve the fluidity of the gear oil. In the present application, the gear oil is filtered through magnetic rods to remove the majority of magnetic particles, then filtered through a mechanical filter to remove fine mechanical particles and subsequently filtered through a fine filter to remove gear oil degradation products, thereby improving filtration efficiency. The present application integrates detection and filtration capabilities, enabling timely detection of gear oil condition, whereby filtration treatment may be performed immediately following detection, with short detection and filtration cycles and prompt response, thereby extending the service life of wind turbine gears and ensuring the reliable operation of wind turbine gearboxes.

Preferably, the system further comprises a heating defoaming module, and the heating defoaming module is connected to the inlet end of the viscosity detection module and the particle contamination detection module, and a first temperature sensor is arranged in the heating defoaming module.

The heating defoaming module is configured to heat and defoam the gear oil; given that the viscosity of gear oil is substantially high, heating enhances the fluidity of the gear oil, while elimination of air bubbles within the gear oil reduces the adverse influence of bubbles on detection accuracy.

Preferably, the viscosity detection module comprises a viscosity detection conduit, and a first control valve and a viscosity detection chamber connected to the viscosity detection conduit, wherein a viscosity detection sensor is arranged in the viscosity detection chamber, and a second temperature sensor is connected to the viscosity detection chamber.

The viscosity detection chamber comprises a constant temperature device, whereby the temperature within the viscosity detection chamber is monitored through the second temperature sensor, and a constant temperature is set according to the detection requirements for gear oil viscosity and density; the viscosity detection sensor can be used to detect viscosity and density parameters of the gear oil.

Preferably, the particle contamination detection module comprises a particle contamination detection conduit, and a second control valve and a particle contamination detection sensor connected to the particle contamination detection conduit.

The particle contamination detection sensor may be selected from wear debris monitoring sensors, image-based particle sensors, and the like. The wear debris monitoring sensor can detect ferromagnetic wear particles. The image-based particle sensor can detect the quantity of particles of different sizes in the gear oil, and can identify the type and morphology of particles above 20 μm, thereby providing data support for wear analysis of the gear oil.

Preferably, the quality detection module comprises a quality detection conduit, and a third control valve and quality sensor connected to the quality detection conduit.

The quality sensor is capable of detecting moisture content, pH level, and the like.

Preferably, the filtration module further comprises a filtration conduit, and a fourth control valve and the filter tower connected to the filtration conduit; the filtration module further comprises a first pressure gauge, a third temperature sensor, a first sampling valve, a first pressure relief valve, and a first oil discharge valve sequentially connected to the filtration conduit along the oil inlet end.

Preferably, the oil inlet port of the parallel conduit is further directly connected to the oil return port of the parallel conduit through an oil discharge conduit.

Preferably, the filter tower is sequentially provided with magnetic rods, a first buffer zone, a mechanical filter, a second buffer zone, a fine filter, and a third buffer zone from the oil inlet end to the outlet end, wherein observation windows are provided in each of the first buffer zone, the second buffer zone, and the third buffer zone.

The magnetic rod is primarily used for filtering the majority of magnetic particles. The mechanical filter may employ a 2 μm magnetic filter screen to achieve filtration of minute mechanical particles. The fine filter employs resin filtration to achieve filtration of components such as gear oil degradation products. The magnetic rod is configured in a detachable manner, enabling timely replacement of the magnetic rod.

Preferably, a second sampling valve and an air release valve are further connected at the third buffer zone.

The present application further discloses a method for monitoring and treating wind turbine gear oil, comprising: using the above system for monitoring and treating wind turbine gear oil, introducing wind turbine gear oil into the viscosity detection module, the particle contamination detection module, and the quality detection module through the oil inlet port, and detecting the viscosity, particle contamination level, and quality of the wind turbine gear oil; when any indicator fails to meet use requirements, operating the filtration module to treat the wind turbine gear oil until all indicators return to normal.

The advantages of the present application are as follows:

The present application performs real-time detection of the viscosity, particle contamination level, and quality of wind turbine gear oil respectively through a viscosity detection module, a particle contamination detection module, and a quality detection module arranged in parallel. The gear oil after detection then returns to the wind turbine gear oil tank. When one or more indicators detected by the viscosity detection module, the particle contamination detection module, or the quality detection module fail to meet operational requirements, the Filtration Module is activated to perform filtration treatment on the gear oil to meet operational requirements. In the present application, the viscosity detection module comprises a constant temperature device to improve the fluidity of the gear oil. In the present application, the gear oil is filtered through magnetic rods to remove the majority of magnetic particles, then filtered through a mechanical filter to remove fine mechanical particles and subsequently filtered through a fine filter to remove gear oil degradation products, thereby improving filtration efficiency. The present application integrates detection and filtration capabilities, enabling timely detection of gear oil condition, whereby filtration treatment may be performed immediately following detection, with short detection and filtration cycles and prompt response, thereby extending the service life of wind turbine gears and ensuring the reliable operation of wind turbine gearboxes.

The heating defoaming module is configured to heat and defoam the gear oil; given that the viscosity of gear oil is substantially high, heating enhances the fluidity of the gear oil, while elimination of air bubbles within the gear oil reduces the adverse influence of bubbles on detection accuracy.

The viscosity detection chamber comprises a constant temperature device, whereby the temperature within the viscosity detection chamber is monitored through the second temperature sensor, and a constant temperature is set according to the detection requirements for gear oil viscosity and density; the viscosity detection sensor can be used to detect viscosity and density parameters of the gear oil.

The particle contamination detection sensor may be selected from wear debris monitoring sensors, image-based particle sensors, and the like. The wear debris monitoring sensor can detect ferromagnetic wear particles. The image-based particle sensor can detect the quantity of particles of different sizes in the gear oil, and can identify the type and morphology of particles above 20 μm, thereby providing data support for wear analysis of the gear oil.

The quality sensor is capable of detecting moisture content, pH level, and the like.

The magnetic rod is primarily used for filtering the majority of magnetic particles. The mechanical filter may employ a 2 μm magnetic filter screen to achieve filtration of minute mechanical particles. The fine filter employs resin filtration to achieve filtration of components such as gear oil degradation products. The magnetic rod is configured in a detachable manner, enabling timely replacement of the magnetic rod.

### BRIEF DESCRIPTION OF THE DRAWINGS

FIG. 1 is a structural schematic diagram of the system for monitoring and treating wind turbine gear oil according to an embodiment of the present application;

FIG. 2 is a structural schematic diagram of the filtration module according to an embodiment of the present application;

In the Figures:
100. Oil Pump;
200. Viscosity Detection Module; 201. First Control Valve; 202. Viscosity Detection Chamber; 203. Viscosity Detection Sensor; 204. Second Temperature Sensor;
300. Particle contamination Detection Module; 301. Second Control Valve; 302. Particle contamination Detection Sensor;
400. Quality Detection Module; 401. Third Control Valve; 402. Quality Sensor;
500. Filtration Module; 501. Filter Tower; 502. Magnetic Rod; 503. Mechanical Filter; 504. Fine Filter; 505. Fourth Control Valve; 506. First Pressure Gauge; 507. Third Temperature Sensor; 508. First Sampling Valve; 509. First Pressure Relief Valve; 510. First Oil Discharge Valve; 511. First Buffer Zone; 512. Second Buffer Zone; 513. Third Buffer Zone; 514, Observation Window; 515. Second Sampling Valve; 516. Air Release Valve; 517. Fifth Control Valve;
600. Heating defoaming module;
700. First One-way Oil Discharge Valve.

### DETAILED DESCRIPTION

To render the objectives, technical solutions, and advantages of the embodiments of the present application more apparent, the technical solutions in the embodiments of the present application will be described clearly and completely hereinafter in conjunction with the embodiments of the present application. It is evident that the described embodiments constitute a portion of the embodiments of the present application, rather than the entirety thereof. Based on the embodiments of the present application, all other embodiments obtained by persons of ordinary skill in the art without exercising inventive effort shall fall within the scope of protection of the present application.

### Embodiment 1

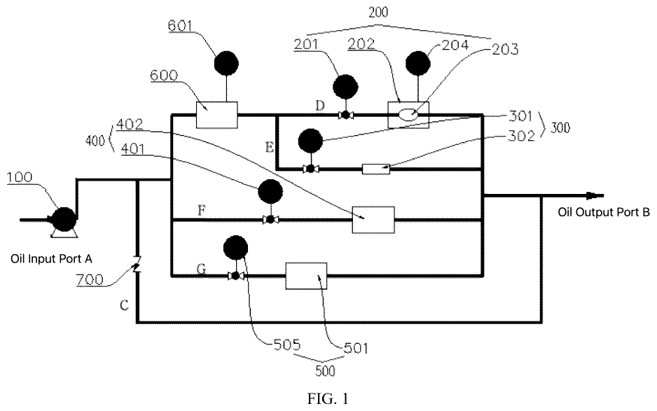

As illustrated in FIG. 1, the system for monitoring and treating wind turbine gear oil comprises an oil pump 100. The inlet end of the oil pump 100 is the oil inlet port A, and the outlet end of the oil pump 100 is connected to the viscosity detection module 200, particle contamination detection module 300, quality detection module 400, and filtration module 500, which are arranged in parallel. The outlet ends of the viscosity detection module 200, particle contamination detection module 300, quality detection module 400, and filtration module 500 are connected to the oil return port B. The viscosity detection module 200 comprises a constant temperature device. The filtration module 500 comprises a filter tower 501, within which magnetic rods 502, a mechanical filter 503, and a fine filter 504 are sequentially arranged along the gear oil flow direction.

In the present embodiment, the system for monitoring and treating wind turbine gear oil further comprises a heating defoaming module 600, wherein the heating defoaming module 600 is connected to the inlet end of the viscosity detection module 200 and the particle contamination detection module 300, the heating defoaming module 600 being configured to eliminate bubbles from the gear oil entering the viscosity detection module 200 and the particle contamination detection module 300, thereby reducing the influence of bubbles on detection accuracy. The heating defoaming module 600 of the present embodiment, in addition to defoaming, further possesses a heating function. The heating means may comprise a heating wire, a heating plate, or other such means, and a first temperature sensor 601 is arranged within the heating defoaming module 600 to regulate the temperature and heat the gear oil. On the one hand, this is attributable to the relatively high viscosity of the gear oil, wherein increasing the temperature can enhance the fluidity of the gear oil and can further facilitate defoaming.

The viscosity detection module 200 comprises a viscosity detection conduit (D), and a first control valve 201 and a viscosity detection chamber 202 connected to the viscosity detection conduit, wherein a viscosity detection sensor 203 is arranged within the viscosity detection chamber 202, and a second temperature sensor 204 is connected to the viscosity detection chamber 202. The first control valve 201 is configured to control the opening and closing of the viscosity detection conduit, the viscosity detection chamber 202 is configured to mount the viscosity detection sensor 203, and the viscosity detection chamber 202 comprises a constant temperature device. The constant temperature device may be a heating wire or a heating plate or the like for heating the gear oil flowing through the viscosity detection conduit to enhance the flowability of the gear oil. The second temperature sensor 204 is configured to detect temperature. The viscosity detection sensor 203 is capable of detecting the viscosity and density parameters of the gear oil. The viscosity detection chamber 202 may be configured to maintain a constant temperature according to the detection requirements for gear oil viscosity and density.

The particle contamination detection module 300 comprises a particle contamination detection conduit (E), and a second control valve 301 and a particle contamination detection sensor 302 connected to the particle contamination detection conduit. The second control valve 301 is configured to open or close the particle contamination detection conduit. The particle contamination detection sensor 302 may be selected from a wear debris monitoring sensor, an Image-based particle sensor, or the like. The wear debris monitoring sensor is capable of detecting ferromagnetic wear particles. The image-based particle sensor is capable of detecting the quantity of particles of different sizes in the gear oil, and is capable of identifying the type and morphology of particles above 20 μm, thereby providing data support for wear analysis of the gear oil.

The quality detection module 400 comprises a quality detection conduit (F), and a third control valve 401 and a quality sensor 402 connected to the quality detection conduit. The third control valve 401 is configured to open or close the quality detection conduit. The quality sensor 402 is capable of detecting moisture content, pH value, and the like.

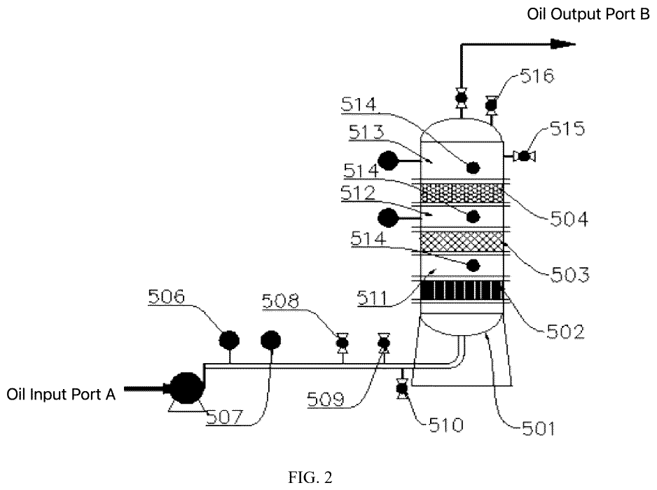

The Filtration Module 500 comprises a filtration conduit (G), and a fourth control valve 505 and the filter tower 501 connected to the filtration conduit. Referring simultaneously to FIG. 2, the filtration module 500 further comprises a first pressure gauge 506, a third temperature sensor 507, a first sampling Valve 508, a first pressure relief valve 509, and a first oil discharge valve 510 sequentially connected to the filtration conduit along the Oil inlet end. The filter tower 501 is sequentially provided with magnetic rods 502, a first buffer Zone 511, a mechanical filter 503, a second buffer zone 512, a fine filter 504, and a third buffer zone 513 from the oil inlet end to the outlet End, wherein observation windows 514 are disposed at each of the first buffer zone 511, the second buffer zone 512, and the third buffer zone 513. A second sampling valve 515 and an air release valve 516 are further arranged in the third buffer zone 513. A fifth control valve 517 is connected to the top end of the filter tower 501.

A supporting base is arranged at the bottom of the filter tower 501 for stability. The gear oil filtered through the magnetic rods 502, the mechanical filter 503, and the fine filter 504 exhibits a certain degree of turbulent flow, and the first buffer zone 511, the second buffer zone 512, and the third buffer zone 513 are respectively configured to stabilize the gear oil.

In the present embodiment, the magnetic rods 502 are positioned at the lowermost location, the mechanical filter 503 is positioned in the middle section, and the fine filter 504 is positioned at the upper location. The arrangement from bottom to top enables an increase in the filtration duration of the gear oil, thereby improving the filtration effect. The magnetic rods 502 are primarily used for filtering the majority of magnetic particles. The mechanical filter 503 may employ a 2 μm magnetic filter screen to achieve filtration of minute mechanical particles. The fine filter 504 employs resin filtration to achieve filtration of components such as gear oil degradation products. Wherein the magnetic rods 502 are of a detachable configuration, enabling timely replacement of the magnetic rods 502.

As shown in FIG. 1, the oil inlet port A of the parallel conduit is further connected directly to the oil return port B of the parallel conduit through an oil discharge conduit (C). A first one-way oil discharge valve 700 is also connected on the oil discharge conduit. When the gear oil requires discharging or is no longer serviceable, discharging may be performed through the oil discharge conduit.

In the present embodiment, the viscosity detection module 200, the particle contamination detection module 300, and the quality detection module 400, arranged in parallel configuration, respectively perform real-time detection of the viscosity, particle contamination level, and quality of the wind turbine gear oil. The detected gear oil then returns to the wind turbine gear oil tank. When one or more indicators detected by the viscosity detection module 200, the particle contamination detection module 300, or the quality detection module 400 fail to satisfy operational requirements, the filtration module 500 is activated to filter the gear oil to meet operational requirements. In the present embodiment, the viscosity detection module 200 incorporates a constant temperature device to enhance the fluidity of the gear oil. In the present embodiment, the gear oil is filtered through the magnetic rods 502 to remove the majority of magnetic particles, passes through the mechanical filter 503 to filter fine mechanical particles, and subsequently through the fine filter 504 to filter gear oil degradation products, thereby enhancing filtration effectiveness. The present application integrates detection and filtration capabilities, enabling timely detection of gear oil condition, whereby filtration treatment may be performed immediately following detection, with short detection and filtration cycles and prompt response, thereby extending the service life of wind turbine gears and ensuring the reliable operation of wind turbine gearboxes.

### Embodiment 2

The present embodiment discloses a method for monitoring and treating wind turbine gear oil, by using the system for monitoring and treating wind turbine gear oil of Embodiment 1 as described above, comprising the following steps: Introducing wind turbine gear oil through Oil inlet port A and divides into two paths, wherein one path passes through the heating defoaming module 600 before entering the viscosity detection module 200 and the particle contamination detection module 300, whilst the other path passes directly through the quality detection module 400, thereby respectively detecting the viscosity, particle contamination level, and quality of the wind turbine gear oil. Where any indicator fails to satisfy operational requirements, the filtration module 500 is activated to treat the wind turbine gear oil until all indicators return to normal.

It should be noted that detection and filtration can be performed simultaneously, enabling real-time monitoring of whether the filtered wind turbine gear oil meets operational requirements. Alternatively, when a certain indicator fails to meet requirements, the control valve on that conduit may be closed and reopened after a period of filtration. If the operational requirements are still not satisfied after reopening, filtration shall continue until all indicators meet the operational requirements.

The above embodiments are provided solely for illustrating the technical solution of the present application and are not intended to limit the application. Although the present application has been described in detail with reference to the foregoing embodiments, persons of ordinary skill in the art should understand that modifications may still be made to the technical solutions described in the foregoing embodiments, or equivalent substitutions may be made to some of the technical features thereof. Such modifications or substitutions do not cause the essence of the corresponding technical solutions to deviate from the spirit and scope of the technical solutions of the embodiments of the present application.

What is claimed is:

1. A system for monitoring and treating wind turbine gear oil, comprising an oil pump; an outlet end of the oil pump is connected to a viscosity detection module, a particle contamination detection module, a quality detection module, and a filtration module arranged in parallel; outlet ends of the viscosity detection module, the particle contamination detection module, the quality detection module, and the filtration module are connected to an oil return port; the viscosity detection module comprises a constant temperature device therein; the filtration module comprises a filter tower, magnetic rods, a mechanical filter, and a fine filter are sequentially arranged in the filter tower along the gear oil flow direction.

2. The system for monitoring and treating wind turbine gear oil of claim 1, wherein the system further comprises a heating defoaming module, and the heating defoaming module is connected to the inlet end of the viscosity detection module and the particle contamination detection module, and a first temperature sensor is arranged in the heating defoaming module.

3. The system for monitoring and treating wind turbine gear oil of claim 1, wherein the viscosity detection module comprises a viscosity detection conduit, and a first control valve and a viscosity detection chamber connected to the viscosity detection conduit, wherein a viscosity detection sensor is arranged in the viscosity detection chamber, and a second temperature sensor is connected to the viscosity detection chamber.

4. The system for monitoring and treating wind turbine gear oil of claim 1, wherein the particle contamination detection module comprises a particle contamination detection conduit, and a second control valve and a particle contamination detection sensor connected to the particle contamination detection conduit.

5. The system for monitoring and treating wind turbine gear oil of claim 1, wherein the quality detection module comprises a quality detection conduit, and a third control valve and a quality sensor connected to the quality detection conduit.

6. The system for monitoring and treating wind turbine gear oil of claim 1, wherein the filtration module further comprises a filtration conduit, and a fourth control valve and the filter tower connected to the filtration conduit; the filtration module further comprises a first pressure gauge, a third temperature sensor, a first sampling valve, a first pressure relief valve, and a first oil discharge valve sequentially connected to the filtration conduit along the oil inlet end.

7. The system for monitoring and treating wind turbine gear oil of claim 1, wherein the oil inlet port of the parallel conduit is further directly connected to the oil return port of the parallel conduit through an oil discharge conduit.

8. The system for monitoring and treating wind turbine gear oil of claim 1, wherein the filter tower is sequentially provided with magnetic rods, a first buffer zone, a mechanical filter, a second buffer zone, a fine filter, and a third buffer zone from the oil inlet end to the outlet end, wherein observation windows are provided in each of the first buffer zone, the second buffer zone, and the third buffer zone.

9. The system for monitoring and treating wind turbine gear oil of claim 8, wherein a second sampling valve and an air release valve are further arranged in the third buffer zone.

10. A method for monitoring and treating wind turbine gear oil, comprising: using the system for monitoring and treating wind turbine gear oil of claim 1, introducing wind turbine gear oil into the viscosity detection module, the particle contamination detection module, and the quality detection module through the oil inlet port, and detecting the viscosity, particle contamination level, and quality of the wind turbine gear oil; when any indicator fails to meet use requirements, operating the filtration module to treat the wind turbine gear oil until all indicators return to normal.
